(19) United States
(12) Patent Application Publication
(10) Pub. No.: US 2006/0061487 A1
(43) Pub. Date: Mar. 23, 2006

(54) Illuminated portable traffic control sign

(76) Inventor: Lawrence L. Heap, Concord, CA (US)

Correspondence Address: Ray K. Shahani, Esq.;ATTORNEY AT LAW, Twin Oaks Office Plaza, 477 Ninth Avenue, Suite 112, San Mateo, CA, 94402-1854, US

(21) Appl. No.: 10/948,378

(22) Filed: Sep. 23, 2004

(51) Int. Cl. G08G 1/095

(52) U.S. Cl. 340/908

(57) ABSTRACT

A portable, hand-held traffic signal device such as for use at traffic intersections and school crossings, comprising: a front, indicia-bearing sign portion for communicating traffic instructions to on-coming traffic; a handle portion coupled to a lower edge portion of the front, indicia-bearing sign portion; and an electrical circuit containing (a) one or more sources of illumination mounted peripherally on the front, indicia-bearing sign portion, (b) a power source and (c) a switch for activating the circuit.

### FIELD OF THE INVENTION

The present invention relates generally to mobile traffic signs, and more specifically to a portable traffic sign that is self-illuminated to provide greater visibility.

### BACKGROUND OF THE INVENTION

Traffic signs are devices placed along, beside, or above a highway, roadway, pathway, or other route to guide, warn, and regulate the flow of traffic, including motor vehicles, bicycles, pedestrians, equestrians, and other travelers. In general, traffic signs should only be placed where warranted or required by facts and engineering studies. Traffic signs should be placed as necessary for safety and proper regulation of traffic. The use of too many traffic signs at a given location may reduce the overall effectiveness of all the signs at that location.

Traffic signs, like any other traffic control device, must meet five fundamental requirements:

Fulfill a need

Command attention

Convey a clear, simple meaning

Command respect from travelers

Give adequate time for proper response

The official manual for signing in the United States is the Manual on Uniform Traffic Control Devices (MUTCD), published by the Federal Highway Administration (FHWA). The MUTCD is a national standard, intended to ensure that signing is consistent throughout the US. The MUTCD is developed and modified by FHWA through the Federal Register rule-making process.

In the United States, a STOP sign has an octagonal shape. It is primarily red in color with a white border and a reversed white colored “STOP” printed in the center. The standard size of a regular road side STOP sign is 30×30 inches. Where greater emphasis or visibility is required, a larger size is recommended. On low-volume local streets and secondary roads with low approach speeds, a 24×24 inch size may be used. The shape, size, typeface, letter size and other specifications of a STOP sign is governed by the MUTCD, as previously mentioned.

A STOP sign means that vehicles must make a full stop before entering a crosswalk or at a white “limit line.” On divided highways, a STOP sign for crossing or turning vehicles is often placed on the island or diving strip. Like other traffic signs, STOP signs are usually permanently secured on sign posts and supports. Wood and steel are the two primary materials used for small sign supports. Larger sign supports, such as cantilever structures or sign bridges, are usually made of steel.

Sometimes there are needs to have temporary STOP signs in school areas, construction sites, street detouring areas, parking lots etc. Usually, the signs are a smaller version of regular STOP signs with a short handle either hand-held by users or secured on a temporary stand such as a traffic cone.

Due to the nature of the sign message and application locations, it is vital for drivers and pedestrians to notice the presence of mobile STOP signs and their bearers. Mobile STOP signs must have very high visibility to demand attention due to their relatively small size, unusual locations and unexpected presence.

Most traffic signs are lit passively by reflecting the head light from approaching vehicles. The signs are usually polished with retroreflective coating so as to increase the reflectivity of incoming light. There are different types of retroreflective surfaces such as basic reflective sheeting which is made of small glass beads, multi-layered reflective sheeting, microprimatic sheeting etc. with different degrees of reflectivity. Regardless of coating materials, those traffic signs are only lit at night and/or during foggy conditions when approaching traffics have their headlights on.

Some school buses are sighted with their retractable STOP signs illuminated by installing a red light bulb in the center of the sign. Those signs are however attached to the buses and henceforth not portable.

### ADVANTAGES AND SUMMARY OF THE INVENTION

The present invention is a portable traffic sign with a self-illumination system that will increase the visibility of the sign tremendously.

An object and advantage of the present invention is to provide a STOP sign which is self-illuminated regardless of lighting conditions in the environment. Power source and light source are both self-contained and can be installed on the STOP sign with no external attachments, making them completely portable.

Another object and advantage of the present invention is to provide portability. Despite additional power source and light source, the STOP sign of present invention is light enough to be carried around by most users.

Another object and advantage of the present invention is to provide a programmable lighting pattern. The LED light fixtures can be wired and programmed in order to have a particular flashing pattern so as to increase visibility of the entire STOP sign of the present invention.

Another advantage of the present invention is to provide versatility to be either hand-held by users or mounted on stationary stands such as traffic cones with minimal installation.

Further objects and advantages of the present invention will be come apparent through the following descriptions, and will be included and incorporated herein.

### BRIEF DESCRIPTION OF THE DRAWINGS

FIG. 1A is a representative front side view of a preferred embodiment of an illuminated portable STOP sign 100 of the present invention.

FIG. 1B is a representative side view of a preferred embodiment of a illuminated portable STOP sign 100 of the present invention.

FIG. 1C is a representative back side view of a preferred embodiment of a illuminated portable STOP sign 100 of the present invention.

FIG. 2A, 2B and 2C are representative front views of alternative traffic signs of the present invention using similar illumination device and arrangement.

FIG. 2D is a representative view showing one of the preferred embodiments of the apparatus and method mounting the illuminated portable STOP sign 100 of the present invention on a stationary stand 316.

FIG. 3 is a representative view showing a preferred embodiment of the apparatus and method of use of the illuminated portable STOP sign 100 of present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

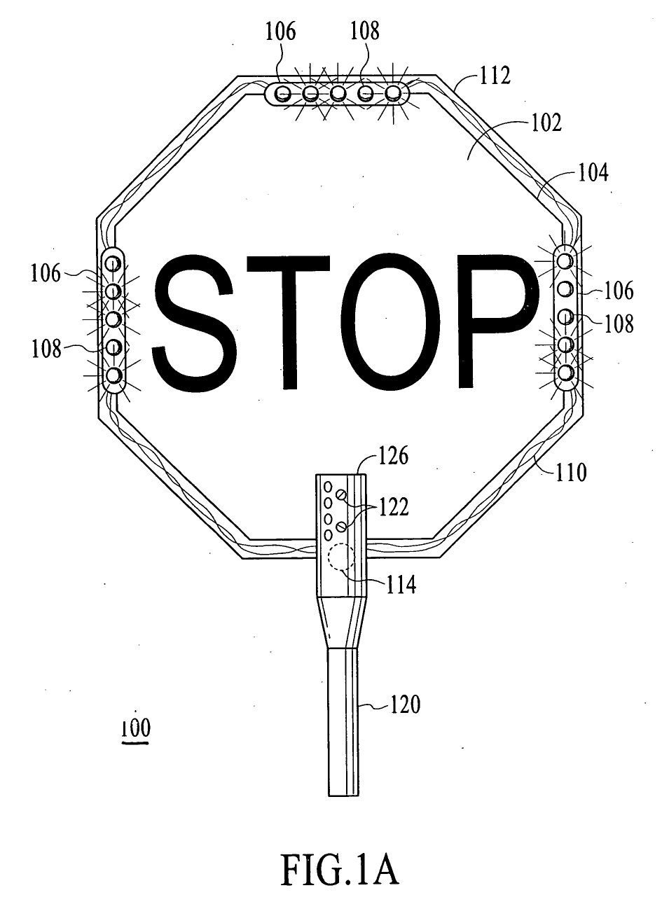

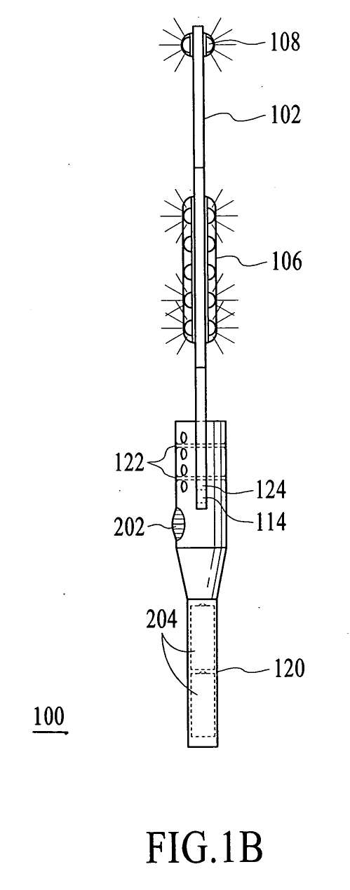

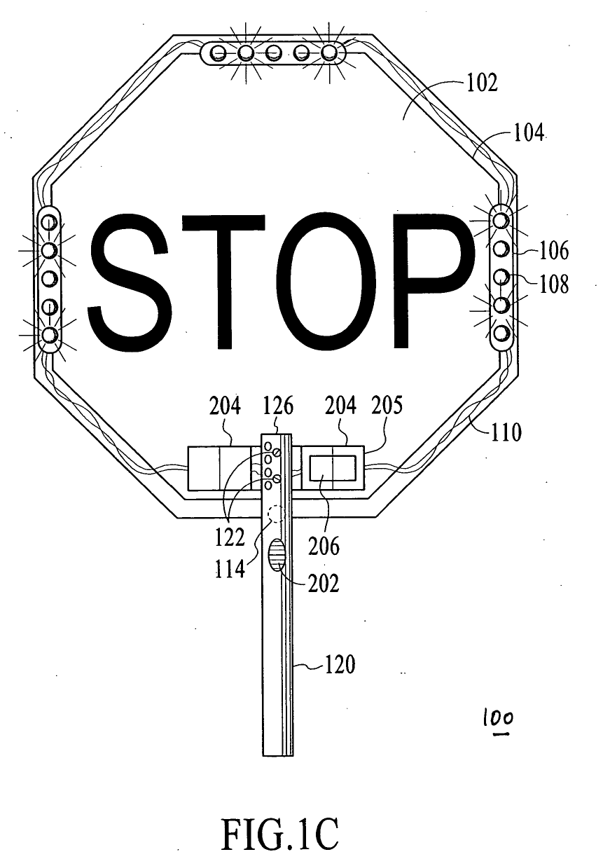

FIG. 1A is a representative front view of a preferred embodiment of an illuminated portable STOP sign 100 of the present invention. The illuminated portable STOP sign 100 of the present invention comprises of two key portions, a flat, sign portion 102 and a handle portion 120.

As shown in FIG. 1A, in a preferred embodiment, the flat sign portion 102 is a portion of flat sheet material in a regular octagonal shape. Sign portion 102 can be made of stainless steel, aluminum or other light, hard and durable materials including plastics, resins, composites, etc. The visual design of flat sign portion 102 is resembling to regular street STOP signs. The design of both sides of flat sign portion 102 of illuminated portable STOP sign 100 of the present invention are the same. Flat sign portion 102 is painted red predominantly with a white border 104 and a reversed white “STOP” is painted in the middle of the design carrying the single-minded message of the sign. As discussed, the shape, typeface, letter size and other specifications of flat sign portion 102 follow the regulating rules by the MUTCD. The surface of flat sign portion 102 could be coated with reflective materials such as retroflective sheeting, glass beads sheeting, “encapsulated lens” sheeting, multi-layer sheeting etc. to improve the visibility of flat sign portion 102 at night and/or in foggy conditions when headlights of incoming vehicles are on.

In a preferred embodiment, a plurality or singularity of LED (light-emitting diode) light set(s) 106 are secured preferably on the border 104 and within the rim 112 of flat sign portion 102. LED light sets 106 can be individual LEDs 108 connected in series by power cable 110 with only one resistor for the whole series string or other circuit arrangements that are known in the art. Alternatively, LED light sets 106 can be existing LED flash light accessories connected in series or other circuit arrangements by power cable 110. By using existing LED light sets 106 that have flashing patterns installed, users can select flashing patterns for the entire illuminated portable STOP sign 100 of the present invention. Also, users can optionally putting LED light sets 106 on places other than the border 104 for even better visibility as long as the “STOP” design element is not visually hindered.

LED light sets 106 are secured on the surface of flat sign portion 102 either by heat-resistant and industrial strength adhesives and/or mechanical means such as bolts and nuts. The circuit on the front panel of flat sign portion 102 and the circuit on the back panel of flat sign portion 102 are connected through a through hole 114 on the bottom part of flat sign portion 102.

As best shown in FIG. 1A, 1B and 1C, LED light bulbs 108 and or incandescent, flourescent or CCFL light bulbs can be installed at the handle tip 126 of handle portion 120 to further increase the illumination effects on the flat sign portion 102 of the illuminated portable STOP sign 100 of the present invention. Thus, a preferred embodiment of the illuminated STOP sign 100 of the present invention has a front, illuminated faceplate or sign portion 102 for increased visibility such as in poor light or inclement weather conditions.

FIG. 1B is a representative side view of a preferred embodiment of a illuminated portable STOP sign 100 of the present invention. As best shown in FIG. 1A and 1B, handle portion 120 is a round, pistol grip, ergonomic or other shape tubular structure with a horizontal slit 124 along the diameter cross-sectionally. The building material of handle portion 120 can be wood, plastic, aluminum or other strong and light material available. In a preferred embodiment, handle portion 120 should be a hollow or semi-hollow tube-like structure in order to reduce the weight of the entire illuminated portable STOP sign 100 of the present invention. Additionally, the space inside handle portion 120 can be utilized to house power cable 110 or even power source 204. The key purpose of handle portion 120 is to provide a grip for users to hold the illuminated portable STOP sign 100 of the present invention. The shape and girth of handle portion 120 should be selected so as to provide a comfortable grip for users. The recommended length of handle portion 120 is in the range of 30 cm to 50 cm, or more or less. The width of horizontal slit 124 should be greater than the thickness of flat sign portion 102 with a comfortable clearance in the range of 1-10 mm or more or less. Horizontal slit 124 acts as a cradle to hold flat sign portion 102 in place and subsequently secured by a plurality of screws 122 along the length of handle portion 120.

FIG. 1C is a representative back view of a preferred embodiment of a illuminated portable STOP sign 100 of the present invention. In a preferred embodiment, one or more LED (light-emitting diode) light set(s) 106 are secured preferably on the border 104 and within the rim 112 of flat sign portion 102. LED light sets 106 can be individual LEDs 108 connected in series or parallel or otherwise by power cable 110 with only one resistor for the whole series string or other circuit arrangements that are known in the art. Alternatively, LED light sets 106 can be existing LED flash light accessories such as Cat-Eye-brand LED-type flashing or programmable bicycle lights connected in series or other circuit arrangements by power cable 110. By using existing LED light sets 106 that have flashing patterns installed or pre-programmed, users can select flashing patterns for the entire illuminated portable STOP sign 100 of the present invention. Also, users can optionally put LED light sets 106 on places other than the border 104, such as on other portions of the flat sign portion 102, for even better visibility as long as the “STOP” design element is not visually hindered.

LED light sets 106 are secured on the surface of sign blade 102 either by heat-resistant and industrial strength adhesive, bonding or other mechanical means such as bolts and nuts. The wiring harness or electrical circuit on the front panel of flat sign portion 102 and the wiring harness or electrical circuit on the back panel of flat sign portion 102 are connected through a through hole 114 on the bottom part of flat sign portion 102.

As shown in FIG. 1C, the two ends of circuit connecting LED light sets 106 on both front and back panels of flat sign portion 102 are connected, such as via wiring harness, to power source 204. Power source 204 is one or more disposable or rechargeable DC or N batteries 206 connected in series or parallel and secured in a casing 205. Power source 204 can be installed on both sides of handle portion 120. Alternatively, power source 204 can be one single fixture installed on top of handle portion 120. In an alternative embodiment, power source 204 can be installed and completely hidden inside a hollow structure of handle portion 120, as best shown in FIG. 1B.

The required voltages to lit up all LED light sets 106 determine the number of batteries 206 needed. In a preferred embodiment, the total voltages of all the LED light sets 106 in the series string should not exceed the range of 80 percent of the supply voltage provided by power source 204. This is to ensure good stability and predictable current consumption. The dropped voltage will then be the supply voltage minus the total voltage of the LED light sets 106 in the series string.

In a preferred embodiment, switch 202 is installed on handle portion 120. The key function of switch 202 is to turn on or off power to the LED light sets, henceforth the whole illuminated portable STOP sign of the present invention. When switch 202 is at the “On” position, electric current will flow through all LED light sets 106 and lit them up. Additionally, with the choice of LED light sets 106 that have flashing patterns installed, switch 202 can be used to select flashing pattern of individual LED light sets 106.

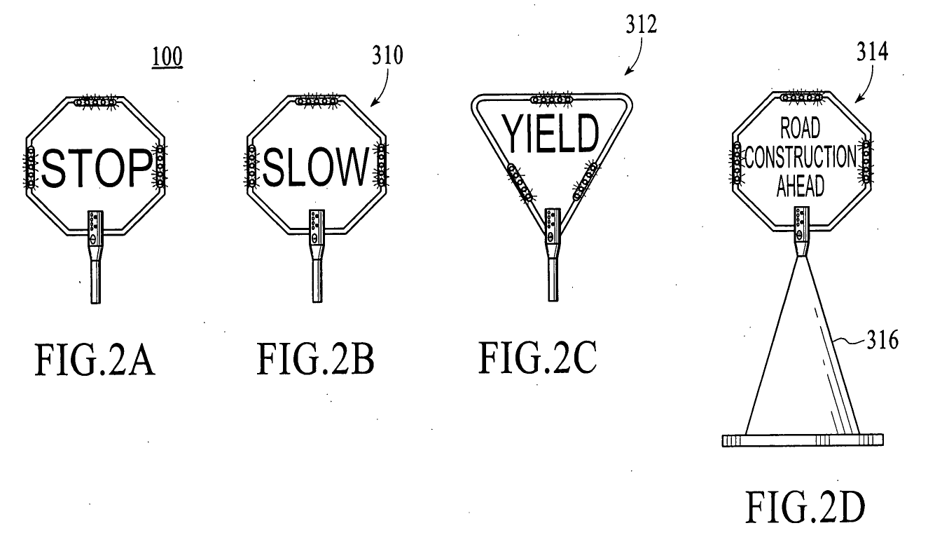

FIG. 2A, 2B and 2C are representative front views of alternative traffic signs of the present invention using similar illumination device and arrangement. As best shown in FIG. 2A, 2B and 2C, LED light sets can be installed on other traffic signs such as SLOW sign 310 or YIELD sign 312. The color, flashing patterns, luminous level, number of LED light sets 106 on individual signs can be determined by selecting a variety of different LED light sets 106.

FIG. 2D is a representative view showing one of the preferred embodiment of mounting the portable illuminated STOP sign 100 of the present invention on a stationary stand 316. As best shown in FIG. 2D, illuminated STOP sign 100 and/or other forth-mentioned illuminated traffic signs 310, 312 etc. can be converted from a hand-held device to a temporary stationary device. For instance, as shown in FIG. 2D, it can be attached to the top of a regular traffic cone by inserting handle portion 120 in the hole on top of a regular traffic cone 316 or by other mechanical means.

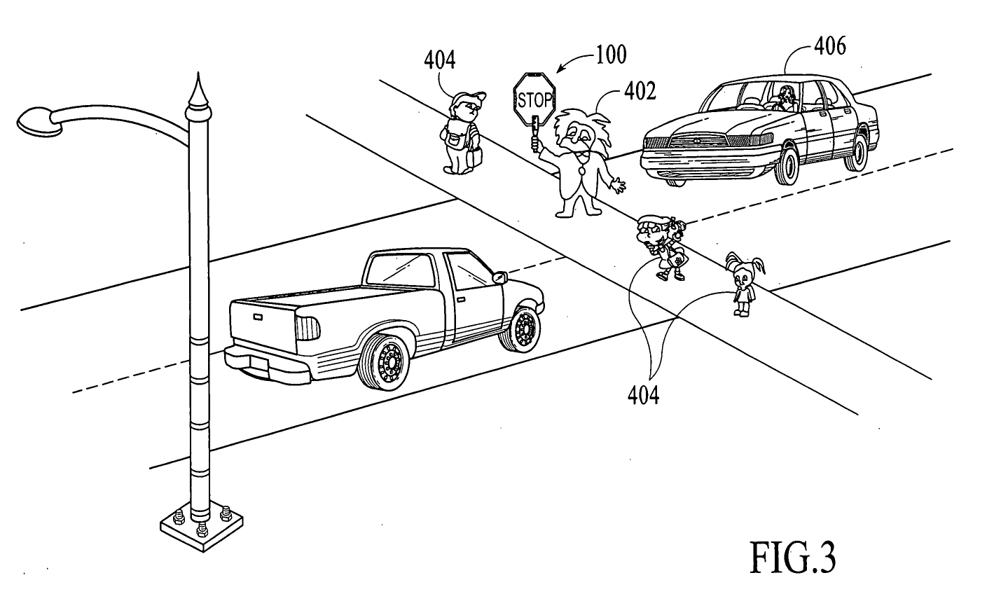

FIG. 3 is a representative view showing a preferred embodiment of the apparatus and method of use of the illuminated portable STOP sign 100 of present invention. As shown in FIG. 3, user 402 holds the illuminated portable STOP sign of the present invention to stop vehicles 406 on both sides of the road in order to allow school children 404 to cross safely. Due to the flashing of LED light sets 106, the illuminated portable STOP sign 100 of present invention is much more visible and demands attention from drivers.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

1. A portable, hand-held traffic signal device such as for use at traffic intersections and school crossings, the traffic signaling device comprising:
a front, indicia-bearing sign portion for communicating traffic instructions to on-coming traffic;
a handle portion coupled to a lower edge portion of the front, indicia-bearing sign portion; and
an electrical circuit containing (a) one or more sources of illumination mounted peripherally on the front, indicia-bearing sign portion, (b) a power source and (c) a switch for activating the circuit.

2. The traffic signaling device of claim 1 in which the power source is disposed within the handle portion.

3. The traffic signaling device of claim 1 in which the power source is disposed adjacent the lower edge portion of the front, indicia-bearing sign portion.

4. The traffic signaling device of claim 1 in which the activating switch is mounted upon the handle portion.

5. The traffic signaling device of claim 1 in which each of the one or more sources of illumination comprises a single incandescent light bulb.

6. The traffic signaling device of claim 1 in which each of the one or more sources of illumination comprises a plurality of incandescent light bulbs.

7. The traffic signaling device of claim 1 in which each of the one or more sources of illumination comprises a single fluorescent light bulb.

8. The traffic signaling device of claim 1 in which each of the one or more sources of illumination comprises a plurality of flourescent light bulbs.

9. The traffic signaling device of claim 1 in which each of the one or more sources of illumination comprises a single LED.

10. The traffic signaling device of claim 1 in which each of the one or more sources of illumination comprises a plurality of LEDs.

11. The traffic signaling device of claim 10 in which each of the plurality of LEDs are preprogrammed to be illuminated in a predetermined sequence.

12. The traffic signaling device of claim 10 in which each of the plurality of LEDs are programmable to be illuminated when desired.

13. The traffic signaling device of claim 1 in which each of the one or more sources of illumination programmable to be illuminated when desired.

14. The traffic signaling device of claim 1 in the handle portion further comprises one or more sources of illumination.

15. The traffic signaling device of claim 14 in which one or more sources of illumination is directed to and upon the front, indicia-bearing sign portion.

16. A method for controlling traffic at locations including school and pedestrian crosswalks and traffic intersections, the method comprising the following steps:
obtaining a portable, illuminated traffic control sign having the desired verbiage upon a front, indicia-bearing sign portion;
illuminating the peripheral portions of the traffic control sign; and
manually displaying the illuminated traffic signal at locations including school and pedestrian crosswalks and traffic intersections during periods of times when children and pedestrians are present.

17. A method for controlling traffic at school crossings in which children may be present, the method comprising the following steps:
obtaining a portable, illuminated STOP sign;
illuminating the peripheral portions of the STOP sign; and
manually displaying the illuminated STOP sign in areas within and adjacent the school crossing when children are present.

18. The method of claim 17 further including the step of illuminating the peripheral portions of the STOP sign with flashing lights.

19. The method of claim 17 further including the step of illuminating the peripheral portions of the STOP sign with one or more LEDs.

20. The method of claim 19 further including the step pre-programming the one or more LEDs as desired.
